(19) United States
(12) Patent Application Publication
(10) Pub. No.: US 2014/0071223 A1
(43) Pub. Date: Mar. 13, 2014

(54) PEER-TO-PEER VIDEO CONFERENCING

(71) Applicants: Samir K. Chatterjee, Salt Lake (IN); Sandeep Bera, Salt Lake (IN); Rabindranath De, Salt Lake (IN)

(72) Inventors: Samir K. Chatterjee, Salt Lake (IN); Sandeep Bera, Salt Lake (IN); Rabindranath De, Salt Lake (IN)

(73) Assignee: REBACA TECHNOLOGIES, Salt Lake (IN)

(21) Appl. No.: 13/607,879

(22) Filed: Sep. 10, 2012

(51) Int. Cl. H04N 7/15

(52) U.S. Cl. 348/14.08; 348/E07.083

(57) ABSTRACT

A method for video conferencing among nodes on a network identifies a host node in a first subnet and one or more additional participating nodes and identifies, from among the additional participating nodes, at least one active participant node. For the host node and for each of the participating nodes, a spanning tree is generated for communication with other nodes. The spanning trees provide multicast communication between a first reflector node and one or more participating nodes in the first subnet, and provide a unicast communication channel between the first reflector node in the first subnet and a second reflector node in a second subnet. The spanning tree for the host node is configured for a unicast communication channel to the at least one active participant node. Video conference content is transmitted from the host node and presented at the participating nodes according to the spanning trees.

### FIELD OF THE INVENTION

This invention generally relates to electronic communication and more particularly relates to an apparatus and method for multi-point peer-to-peer video communication.

### BACKGROUND

Expanded bandwidth capacity and transmission speeds make it possible to transfer a considerable amount of video and audio data between users of desktop and portable computing devices, including cellular phones, laptop computers, computer pads, tablets, and other digital electronic apparatus. Even with these advances in network capacity and improved response times, however, there is still a need for low-cost, capable video communication tools to support widespread video-conferencing (VC) and related activities that involve real-time transmission of audio and video streams between two or more sites.

There are a number of methods for implementing multi-point communication between networked devices. Internet protocols, for example, support simple unicast communication, in which separate connections are provided between communicating sites. With unicast connection, where there are N parties to a transmission, or N nodes, there must be (N-1) separate connections over which the data is transmitted. The same data is transmitted (N-1) times.

An alternate method is multicast communication, supported by some types of internet server devices. In multicast transmission, receivers of data are grouped so that a single transmission provides the same data to each receiving apparatus in a group. Since only one copy of data is sent, the heavy traffic introduced by the multi-endpoint system is greatly reduced. Because of this advantage, many multicast protocols have been developed, such as Internet Group Management Protocol (IGMP), Distance Vector Multicast Routing Protocol (DVMRP), Core Based Tree (CBT), Protocol Independent Multicast (PIM) for Intra-AS multicast, and Border Gateway Multicast Protocol (BGMP) for Inter-AS multicast. For IP multicast, however, all of the intermediate routers must be IP Multicast enabled and Class D IP addresses must be used Likewise, any firewalls in the communication channel must be properly reconfigured, group information must be managed, and all of the receivers must have network interface hardware and software that supports IP multicast protocol.

As a result, other methods have been designed to make multi-endpoint communication more feasible. Unicast-based multicast is one such method. As most Internet protocols are designed for unicast, this type of solution can be implemented in a straightforward manner and a number of development tools exist. Since all IP routers support unicast communication, special multicast routers are no longer needed, allowing applications to run on any network. No group management is involved, and no Class D IP addresses are needed. In one approach, a server sends data to two (or more) receivers by unicast. Thereafter, each receiver rebroadcasts the data to two more receivers. This pattern repeats as needed, forming a multicast tree. Except for the root node (server) and leaf nodes, each intermediate node acts as both a receiver and a transmitter and is sometimes referred to as a “repeater.” Each repeater not only plays the data stream back to its audience, but also transmits the data stream to two or more child nodes.

Unicast-based multicast has advantages of lower cost and increased flexibility, but problems remain. There is still considerable bandwidth requirement for the transmitting network and substantial workload on host and active participant processors. Repeater response times can vary, delaying transmission to some portion of a participating audience. It can be difficult to scale this type of approach beyond a few dozen participants.

Thus, it can be seen that there is a need for a low-cost, peer-to-peer networking approach that reduces the amount of network communication traffic and is readily configurable for a set of nodes having a variable number of participants.

### SUMMARY

It is an object of the present invention to advance the art of video conference networking. With this object in mind, the present invention provides a method for video conferencing among a plurality of nodes on a network, the method comprising:
(a) identifying, from the plurality of nodes, a host node in a first subnet and one or more additional participating nodes;
(b) identifying, from among the one or more additional participating nodes, at least one active participant node;
(c) generating, for the host node and for each of the one or more participating nodes, a spanning tree for communication with other nodes in the network, wherein the generated spanning trees provide multicast communication between a first reflector node in the first subnet and one or more participating nodes in the first subnet, wherein the generated spanning trees provide a unicast communication channel between the first reflector node in the first subnet and a second reflector node in a second subnet, and wherein the spanning tree generated for the host node is configured for a unicast communication channel to the at least one active participant node;
and
(d) transmitting video conference content between the host node and the one or more additional participating nodes according to the generated spanning trees and presenting the transmitted content at the host node and at each of the participating nodes.

According to an alternate aspect of the present invention, there is provided a method for setup of a video conference session among a plurality of nodes on a network, the method comprising:
(a) identifying, at a user interface for a computer at a host node, one or more additional participating nodes for the session;
(b) assigning at least one of the participating nodes as an active participant node;
(c) assigning at least one of the participating nodes as a reflector node that communicates with the host node using unicast communication and that communicates with one or more of the additional participating nodes using multicast communication; and
(d) transferring and presenting video conference content at each of the plurality of nodes in the network.

It is a feature of the present invention that it employs existing network hardware, eliminating the need for dedicated server components that are specially designed to support videoconferencing message propagation.

It is an advantage of the present invention that it provides a configurable peer-to-peer video conference architecture that maintains acceptable latency between extreme end-points in a network.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings.

FIG. 1 is a schematic block diagram that shows an exemplary network arrangement for peer-to-peer video conferencing according to an embodiment of the present invention.

FIG. 2 is a schematic diagram showing a routing tree for communication between a host node and other nodes for a videoconferencing session.

FIG. 3 is a diagram showing a connectivity matrix between users.

FIG. 4 is a schematic diagram that shows a spanning tree generated for a host node.

FIG. 5 is a schematic diagram that shows a spanning tree generated for a participant node.

FIG. 6 is a logic flow diagram that shows a sequence for setting up and conducting a VC session according to an embodiment of the present invention.

FIG. 7 is a plan view of a user interface screen for meeting management.

FIG. 8 is a plan view of a user interface screen for populating the database of users or nodes for scheduling VC sessions.

FIG. 9 is a plan view of a session monitor screen according to an embodiment of the present invention.

### DETAILED DESCRIPTION

It is to be understood that elements not specifically shown or described may take various forms well known to those skilled in the art. For example, embodiments of the present invention can be used in numerous possible network arrangements, using various types of network connections and protocols and using various types of computer systems and personal communications devices. The description that follows shows only a small number of possible arrangements for networked devices using embodiments of the present invention.

Figures shown and described herein are provided in order to illustrate key principles of operation and functional relationships according to the present invention and are not drawn with intent to show actual hardware or software components. In the drawings and text that follow, like components are designated with like reference numerals, and similar descriptions concerning components and arrangement or interaction of components already described are omitted.

Where they are used, the terms “first”, “second”, and so on, do not necessarily denote any ordinal, sequential, or priority relation, but are simply used to more clearly distinguish one element or set of elements or processes from another, unless specified otherwise. The term “video conference content” refers to video data and corresponding audio data for presentation, that is, for display and audio playback.

In the context of the present disclosure, the term “node” is used to denote any of the different types of computer server, computer work station, personal computer, and other computer equipment as well as personal communications devices such as cellular phones, smartphones, tablets, and other devices that have at least some type of computer processing component and that can be connected on a network, using either a wired or wireless connection, as well as other hand-held processing devices of various types. Each node presents video conference audio and video content to a user, or participant. Different types of hardware can be provided at each node, including camera, microphone, keyboard or keypad, and display components, for example. Participating nodes include all of the nodes on the network that communicate during a videoconferencing (VC) session, also termed a “meeting” in the present disclosure. These nodes each present VC video data and audio output for the corresponding sound content. This includes Host node, nodes designated as Active Participant nodes, and all other nodes designated as Passive Participant nodes. Passive Participants are considered to participate in the VC session, and have this content presented, even though they are in “listen only” mode.

A server (not shown in network figures) provides services such as user meeting management, user authentication, spanning tree generation, and related management functions for the VC session. The server is a separate computer apparatus, in public domain or private domain, based on the type of network that serves the various nodes that participate in the VC session. For example, the server can be for intranet networking, internet networking, or a combination of intranet and internet networking.

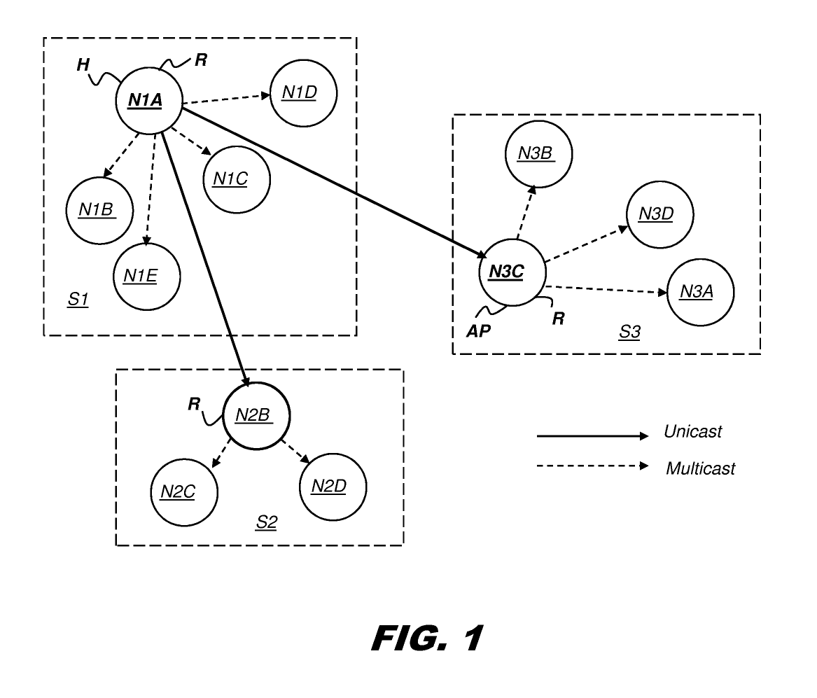

Referring to FIG. 1, there is shown an exemplary network arrangement for peer-to-peer video conferencing according to an embodiment of the present invention. The communication network is set up as a spanning tree, connecting various nodes, with each node having a label of the form Nuv, wherein u is an integer and v is an alphabetic designator. Nodes are organized into three islands S1, S1, and S3 that generally correspond to subnets or other localized network groups. Nodes N1A, N1B, N1C, N1D, N1E are part of a first subnet that is designated island S1; nodes N2B, N2C, N2D in a different subnet outside of the first subnet are part of island S2; nodes N3A, N3B, N3C, N3D in yet another subnet are part of island S3.

Various nodes in the FIG. 1 arrangement have different functions assigned for transmitting and receiving video conference content during a particular VC session. Node N1A is a Host node H for the videoconferencing (VC) session. Node N3C is designated as an Active Participant AP. Nodes N1A, N2B, and N3C are designated as Reflector nodes R. Each island can have one or more Reflector nodes R whose function is to relay the received video conference content data to one or more nodes within the island and to communicate this data with Reflector nodes in other islands.

The communication mode that is used between any two nodes depends on their relationship in the VC session schema. In addition to Host H to Active Participant AP connection, inter-island communication, that is, communication between the reflector nodes R of different islands is unicast; however, intra-island communication is multicast. In case of a Unicast-Multicast meeting, if Host and AP nodes are in different islands, the Host and AP nodes also act as Reflector nodes R of their respective islands and communicate with each other using Unicast communication. Unicast communication links or channels are shown by bold lines in the FIG. 1 configuration. Multicast communication links are represented using dashed lines. As described previously and shown in FIG. 1, communication from Host H to Active Participant AP is unicast; communication between Reflector nodes R is also unicast. Communication from Reflector nodes R to other nodes within the island is multicast.

It is instructive to observe that the arrangement shown in FIG. 1 is for a single VC session, set up and managed through host node N1A. A subsequent VC session, set up wherein some other node is host, for example, would have a different spanning tree arrangement, based on its own VC session setup. The multicast/unicast communication mode links would likely be changed based on the designated Host H and Active Participant(s) AP. Different Reflector nodes R could also be designated in the different islands. A subsequent VC session, even a session with all of the participating nodes shown in FIG. 1, can have a different arrangement of Host, Active Participant, Reflector, and other participant nodes. In a subsequent VC session, for example, node N2D may be the Host node H, with nodes N1B, N3A, and N3D as AP nodes. With such an arrangement, node N2D, node N1B, and either of nodes N3A or N3D can serve as Reflector nodes R.

The Host node is the moderator of a meeting or VC session. In the example of FIG. 1, there is a single moderator at host node N1A. Alternately, a VC session can have multiple moderators or Hosts, with multiple Active Participants and Passive Participants. The number of moderators, whether single or multiple, can be configured during meeting scheduling. Where there is a single moderator, the moderator becomes the Host. Where there are multiple moderators, the moderator who joins first acts as a Host.

During a VC session with multiple moderators, any of the moderators can request to become a Host using a “Host Hand Raising” sequence. On receipt of this type of request, the present moderator acting as Host can “pass the baton” to the requesting moderator, thus making the requestor a Host. Once the “baton” is passed and this new Host assignment is made, a new Host spanning tree is generated and the re-configured VC session can commence. Spanning trees for Host and AP nodes are not formed until the Host joins the meeting.

It should be noted that the spanning tree arrangement shown in FIG. 1 does not require specific hardware for any of the nodes. This arrangement is dynamically configured, designed to support a single VC session, as defined and initiated at host node N1A in the example shown.

The network configuration that is used can be intranet or internet or a combination of intranet and internet, varying between and within islands. In an intranet configuration, routers and switches can be multicast enabled, thus forming a multicast island. Alternately, the routers and switches of an intranet can be multicast-disabled. There can be a network configuration wherein Level 2 routers and switches are multicast enabled and Level 3 routers are multicast disabled. These Level 3 routers form a Wide Area Network (WAN). In this type of arrangement, Local Area Networks (LAN) or Metropolitan Area Networks (MAN) formed by an arrangement of Level 2 routers and switches provide independent multicast islands. Interconnecting these multicast islands using Level 3 routers forms a WAN. Identification of the connectivity topology between the participating end points of the VC architecture in a particular case enables efficient use of a combination of multicast and unicast mode communication, with efficient utilization of network bandwidth.

The network is modeled as a spanning tree and the connectivity matrix is formed using Dijkstra's shortest path algorithm for a weighted graph. Dijkstra's shortest path algorithm is a familiar tool to those skilled in the network communications arts. The weighted parameters include parameters such as computational performance of the nodes, link condition in terms of packet loss, network jitter, the node's upstream bandwidth, and the like. Weaker nodes (that is, nodes with low weighted parameters) are positioned towards the bottom of the graph, while stronger nodes are positioned towards the top. Since VC activity generates audio/visual (A/V) data of all the viewable participants, a weighted graph needs to be calculated for all the nodes streaming A/V.

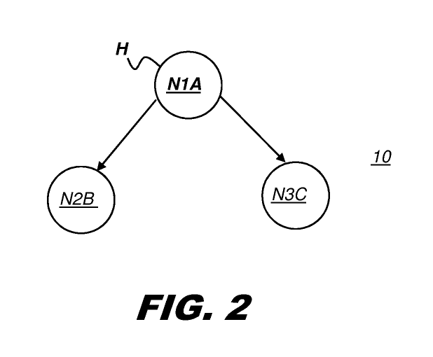

FIG. 2 shows a routing or spanning tree 10 for unicast channel communication between the Host node H and other nodes for a typical VC session, shown as nodes N2B and N3C. A separate routing or spanning tree is generated for each participating node in the VC session.

### Network-ID Assignment

Modeling a network involves identifying the nodes that form an island, clustering them together and defining a network-ID for each node. As nodes may be joining the VC session at different times, it is useful to dynamically identify whether the node is a part of a unicast channel or multicast island and assign the network-ID accordingly. The mechanism for assigning a network-ID to a node is termed dynamic network-ID generation. Once the network-ID is assigned to a node, the node is identified by its dynamically assigned network-ID.

The format of a network-ID is a data structure with data elements designated b0-b8, wherein:
b0 represents the network interface type of the node i.e. public (0) or private (1) interface;
b1-b5 represent the sub network-ID;
b6-b7 represent the network-ID;
b8 is set to indicate “N”.

For example, a first client, node 1, who is joining a meeting from a private network, is assigned dynamic network-ID “N01000011”. When the next node, node 2, joins the VC session, node 2 first checks whether it is in the same multicast island with node 1. If it is not in the same multicast island it checks for its “reachability”, that is, ability to reach node 1. If it is able to reach node 1, node 2 is then in the same network with node 1 but in different sub network. The node populates its network-ID as “N01 (TrackingID 5 Digit, as X characters) 1” and sends this ID to the server.

After receiving the network-ID, the server checks to determine whether node 2 is from a public or from a private network. If this node is from a private network, then the network-ID is used; otherwise the server changes b0 to 0. Then the server sends back the complete network-ID, for example “N01000021” (where 00002 is the Tracking ID assigned by the server in this example) to node 2, indicating that it is same private network as node 1 but in a different sub-network. If the above mentioned reachability test fails, the node is in a different network and sends a web service request to the server requesting the server to assign a new network-ID. The server responds back with a new network-ID, for example, “N02000011”.

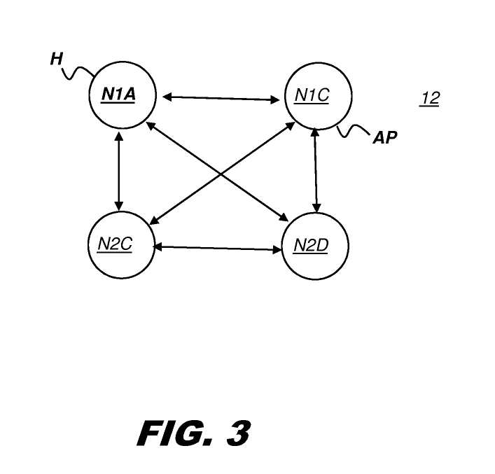

Once the nodes intended to participate in a VC session are indicated by the host, using procedures described in more detail subsequently, generation of a routing tree can be performed. An example routing tree with four nodes N1A, N1C, N2C, N2D, connected in a mesh form in an example network shows this general sequence, with steps illustrated in FIGS. 3, 4, and 5:
(i) Build a connectivity matrix 12 between users. The connectivity matrix 12 shows connections that must be made between nodes. FIG. 3 shows a simple connectivity matrix 12 for an exemplary VC session with only four nodes.
(ii) Generate a preference list for Host data reflection, using the network-ID generated for each participating node. This is a list of Reflector nodes R, along with connectivity status and assigned priority for each Reflector node R.
(iii) Generate a weighted graph using the preference list.
(iv) Generate a minimum spanning tree between nodes by applying Dijkstra's algorithm or other utility. Special preference is given to AP-to-Host connection, with the AP directly connected to the Host. Repeat this process for the Host and for each participating node.

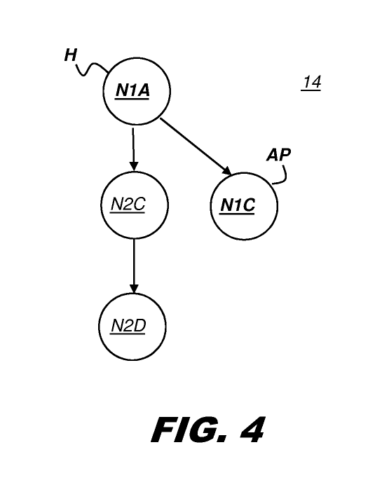

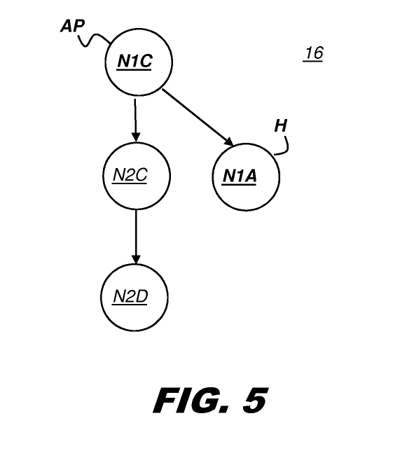

FIG. 4 shows a spanning tree 14 generated for Host node N1A. FIG. 5 shows a spanning tree 16 generated for Active Participant AP node N1C.

### Setup for VC Session

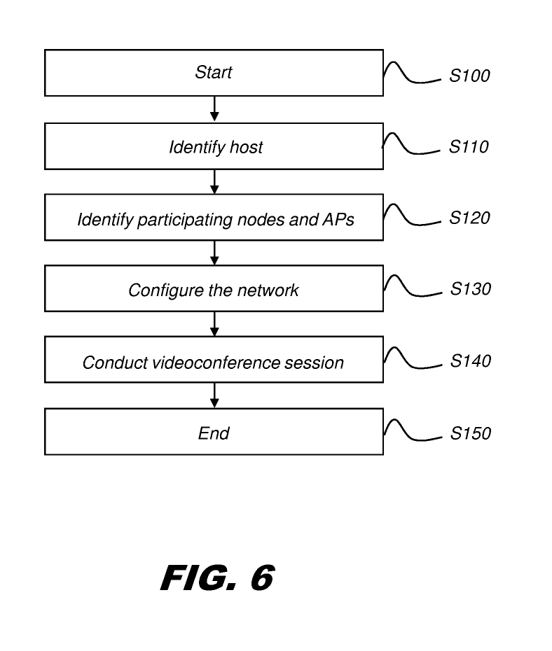

The logic flow diagram of FIG. 6 shows a sequence for setting up and conducting a VC session according to an embodiment of the present invention. An initialization step S100 begins the setup process. An identify host step S110 and an identify participating nodes step S120 define initial relationships for network configuration and communication. A configuration step S130 then configures the network for the VC session, such as described previously with reference to FIG. 1. The VC session commences and is executed during a conduct VC session step S140 that begins with the defined network configuration, tracks or monitors communication performance, and responds dynamically to various events that may require reconfiguration. A termination step S150 then ends the VC session.

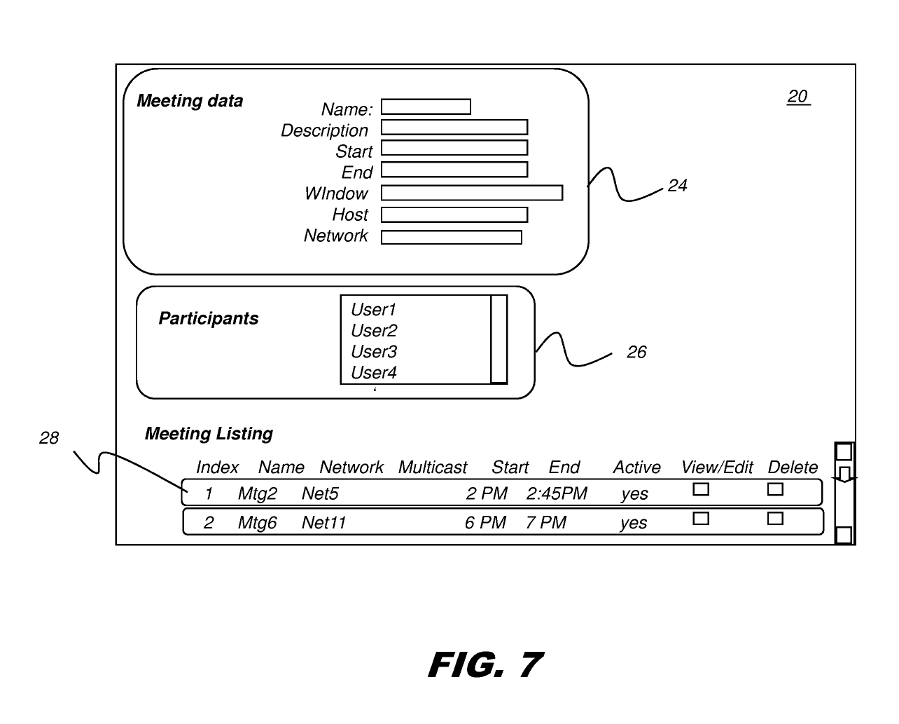

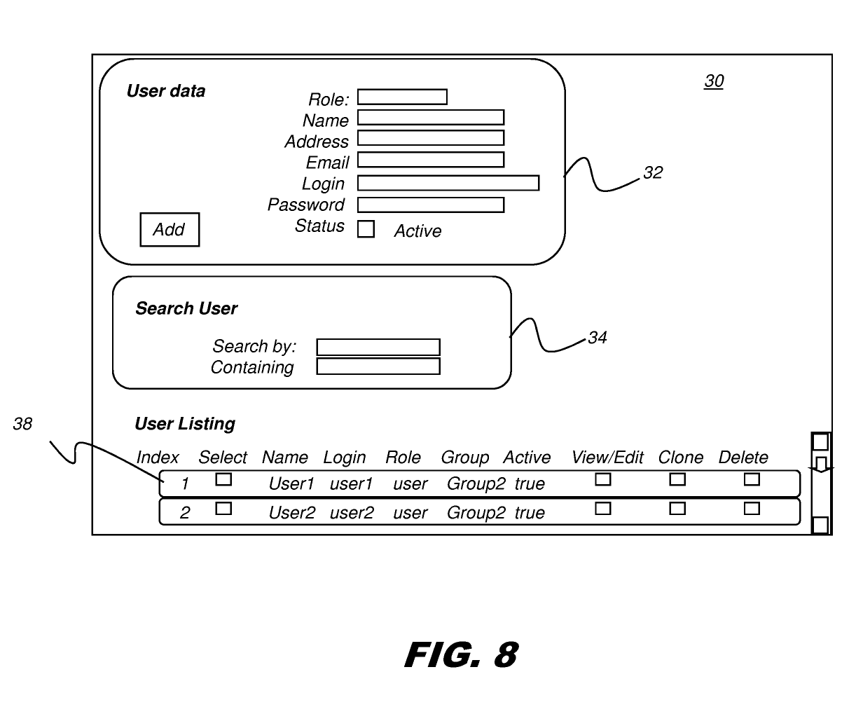

In steps S110 and S120 of the FIG. 6 sequence, the Host H is the node that initiates VC session setup and defines who participates in a particular VC session. According to an alternate embodiment of the present invention, a System Administrator or other user with permission to configure the system can assign the Host node appropriately. FIGS. 7 and 8 show examples of the user interface that is used for setting up the VC session according to an embodiment of the present invention. Referring to FIG. 7, a meeting management screen 20, edited by the Host H user or by a System Administrator, has a meeting data section 24, a participants list 26 and a meeting listing 28 for setup and management of one or more VC sessions. Meeting data section 24 includes data fields for name of the meeting (VC session), description, start and end times, window arrangement for viewing other participants, Host name, network type, and other useful data. Participants list 26 enables selection of two or more participants for the VC session. It can be appreciated that FIG. 7 is exemplary; numerous other data fields can alternately be provided for meeting management.

FIG. 8 shows a user management screen 30 that is used to populate the database of users (nodes) for scheduling VC sessions. Entry of data on this screen is the job of the System Administrator or other operator. A user data section 32 accepts operator entries for user information including fields for role of the user, such as Host, moderator, Active Participant, or general participant; name, address, and email information; login and password information, which can be used to group two or more users of the same type, for example; user status, whether active or inactive, and the like. A search section 34 enables the operator to search through a user listing 38 that contains multiple user entries. Searching can be by user name, for example, or by network type or other parameter.

Each participating node has access to the needed software for supporting its own configuration for the VC session and for overall interaction with other nodes in the network. Software for initiating and managing the VC session is downloaded from a networked server location (not shown) to each participating node. Software download or update from the server can be automatically executed or may be executed as part of the VC session initiation process.

In order to participate in the VC session, each node needs to login to the server for authentication. Once the user authentication process is complete, the user is prompted with a pop-up for downloading or updating the current VC software identified at that node. According to an embodiment of the present invention, download or update of VC software is automatically performed for each node once the user selects the software download or upgrade during the user login phase.

### Configuration of the Network Nodes

Given the setup of the user database and the individual VC session from steps 110 and 120 of the FIG. 6 sequence, configuration step S130 can be executed by Host H and by the downloaded VC software that runs on the Host's computer or on another computer, work station, or server. According to an embodiment of the present invention, Host H provides message content that instructs each node in the network that will act as a participating node, identifies the Host H and Active Participant AP nodes, and sets the network configuration in motion.

As was described with reference to FIG. 1, there can be one or more islands S1, S2, S3, . . . that correspond to network subnets. Each island, in turn, communicates to Host H through a Reflector node R, one of the computers or other processors within that island. The server first determines how many subnets or islands there are and how many Reflector nodes R are needed. Then, the server queries each node of each of the subnets to identify the system that is best suited to serve as Reflector node R for a particular subnet. According to an embodiment of the present invention, the first user node that joins from an island is considered, by default, as the Reflector node for that island. This assignment can be changed, however, during the configuration phase, based on information obtained from other nodes within the subnet or island. If, from the gathered information, the server finds a node that would operate more efficiently as Reflector node, the server assigns that node as Reflector and generates the spanning tree accordingly based on Dijkstra's algorithm. Attributes that are used to determine which system(s) best serve this function include CPU speed, memory, availability, link conditions and tracked performance statistics, and the like. Once the Reflector node R is identified, the respective spanning trees for participating nodes within each subnet can be defined. Multicast communication is set up between the Reflector node R and each participating node within the subnet. Unicast communication is set up between each Reflector node R and its peers.

During network communication, the speed and overall performance of the communication link for transferring video conference content is continually measured and monitored by the host and other participating nodes to determine the condition and performance of its parent and child nodes. According to an embodiment of the present invention, in the process for monitoring the communication link, each node of a tree monitors the RTCP (Real Time Transport Control Protocol) data for packet loss and network jitter of its parent and children, if any, at periodic intervals. Each node sends this information; along with the node's own CPU and memory usage information, to the server for tree regeneration if needed. According to an embodiment of the present invention, the algorithm followed for spanning tree generation and regeneration is as follows:
(i) Each node has an assigned priority value based on whether the node is a Host H or Active Participant AP, on whether the node is from public IP or private IP, and on known performance criteria, such as whether the node is connected via wired interface or wireless interface, for example.
(ii) For each of the nodes, the server stores an assigned priority value along with corresponding calculated values for each node obtained from a set of collected input parameters, such as CPU and memory usage, bandwidth, link condition, (tracked packet loss and network jitter) and other factors.
(iii) Upon receiving a set of N (a programmable integer value) input parameters (such as CPU and memory usage values, bandwidth, link condition from performance tracking, and other parameters) from all nodes except the Host and Active Participant(s), a set of “Connectivity Status” or performance values for each node is calculated at the server.
(iv)The set of N calculated “Connectivity Status” values and corresponding priority values are stored in the server.
(v) For each link or pair of nodes, there is defined a “Sensitivity Parameter” based on the type of network connectivity, considering factors such as optical fiber bandwidth, wireless performance, or wired broadband connection.

Tree regeneration logic is based on the defined “Sensitivity parameter”, such as by comparison with a configurable value. If the difference between the last two calculated Connectivity Status values and the current value is outside the range with the following bounds:
((current reference of calculated value+“Sensitivity value”); and
(current reference of calculated value−“Sensitivity value”)),
   then the priority of the node is changed accordingly and a tree regenerated for the node under consideration and for nodes below that node.

A participant may join the VC session once it is already in progress. If the new participant is already invited to the VC session, a simple logon procedure is used to join the ongoing session. For a new participant not on the original invitation list, a spanning tree regeneration algorithm, as just described, is applied for making connections to the new participant node.

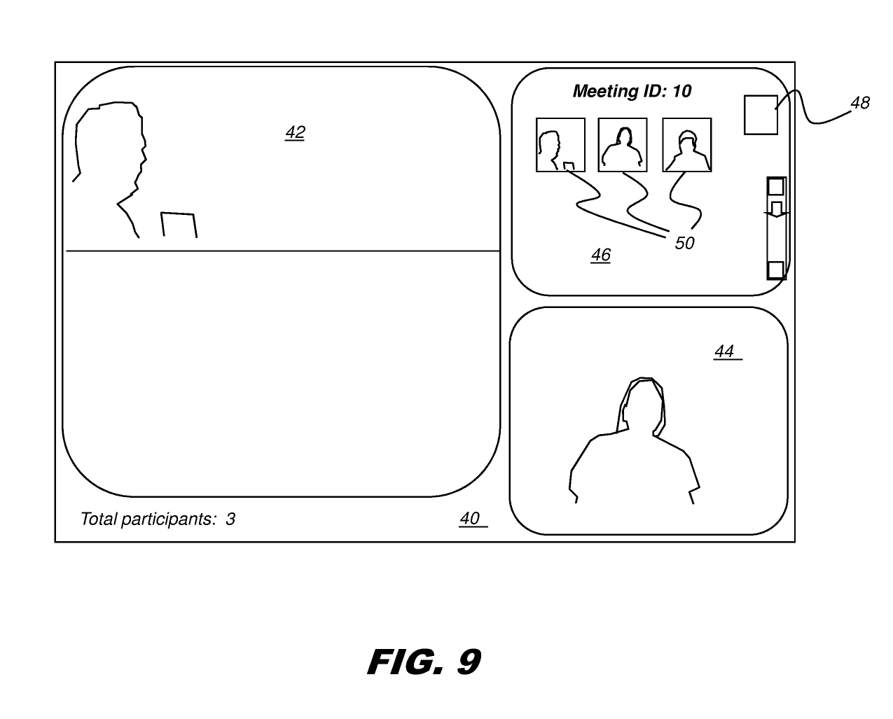

The host user interface can be used to change the status of a participant node during the VC session. FIG. 9 shows a session monitor screen 40 that displays video content of various participants to the host and to other participants in the active VC session. A host panel 42 shows the Host node participant for the session. An active participant panel 44 shows an Active Participant. A participants panel 46 provides a set of reduced-size or thumbnail images 50 of VC session participants. Clicking on or otherwise selecting a request icon 48 enables a participant to request participation in the VC session, such as having a status change to Active Participant, upon approval from the host. Additional utilities for the host, not shown in the example of FIG. 9, enable selection of Active Participant(s), selective blanking of the screen, or other control functions for the VC session.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. The invention is defined in the claims.

1. A method for video conferencing among a plurality of nodes on a network, the method comprising:
(a) identifying, from the plurality of nodes, a host node in a first subnet and one or more additional participating nodes;
(b) identifying, from among the one or more additional participating nodes, at least one active participant node;
(c) generating, for the host node and for each of the one or more participating nodes, a spanning tree for communication with other nodes in the network, wherein the generated spanning trees provide multicast communication between a first reflector node in the first subnet and one or more participating nodes in the first subnet, wherein the generated spanning trees provide a unicast communication channel between the first reflector node in the first subnet and a second reflector node in a second subnet, and wherein the spanning tree generated for the host node is configured for a unicast communication channel to the at least one active participant node;
and
(d) transmitting video conference content between the host node and the one or more additional participating nodes according to the generated spanning trees and presenting the transmitted content at the host node and at each of the participating nodes.

2. The method of claim 1 wherein the at least one active participant node is outside the first subnet.

3. The method of claim 1 further comprising designating a participant node as a second active participant node and regenerating the spanning tree for the second active participant node.

4. The method of claim 1 further comprising re-generating the spanning tree for one or more participating nodes according to performance tracking of the first or second reflector node.

5. The method of claim 1 wherein generating the spanning tree comprises forming a connectivity matrix between the one or more participating nodes in the network.

6. The method of claim 1 wherein identifying the at least one active participant node is performed according to an operator instruction at the host node.

7. The method of claim 1 wherein generating the spanning tree comprises using Dijkstra's algorithm.

8. The method of claim 1 wherein one node of the plurality of nodes serves as both the host node and the first reflector node.

9. The method of claim 1 further comprising:
(e) re-assigning the host node to become a participant node;
(f) identifying, from the plurality of nodes, an alternate host node; and
(g) assigning the alternate host node as the host node.

10. The method of claim 9 further comprising regenerating the spanning tree according to the assigned host node.

11. The method of claim 1 wherein the second reflector node is the first node that joins a video conference session from the second subnet.

12. The method of claim 1 further comprising displaying the video conference content that is transmitted from the host node to at least one of the participating nodes.

13. A method for setup of a video conference session among a plurality of nodes on a network, the method comprising:
(a) identifying, at a user interface for a computer at a host node, one or more additional participating nodes for the session;
(b) assigning at least one of the participating nodes as an active participant node;
(c) assigning at least one of the participating nodes as a reflector node that communicates with the host node using unicast communication and that communicates with one or more of the additional participating nodes using multicast communication; and
(d) transferring and presenting video conference content at each of the plurality of nodes in the network.

14. The method of claim 13 wherein the reflector node is in a different subnet than the host node.

15. The method of claim 13 further comprising generating a spanning tree for each of the host and participating nodes.

16. The method of claim 15 further comprising re-generating the spanning tree for one or more participating nodes according to detected performance of the participating nodes.

17. The method of claim 15 wherein generating the spanning tree comprises forming a connectivity matrix between the one or more participating nodes in the network.

18. The method of claim 15 wherein generating the spanning tree comprises using Dijkstra's algorithm.
